(19) United States
(12) Patent Application Publication
(10) Pub. No.: US 2026/0043730 A1
(43) Pub. Date: Feb. 12, 2026

(54) METROLOGY APPARATUS AND METHOD

(71) Applicant: Cymer, LLC, San Diego, CA (US)

(72) Inventors: Tsungchan Tsai, San Diego, CA (US); Mohammad Amin Khamehchi, San Diego, CA (US)

(21) Appl. No.: 18/707,413

(22) PCT Filed: Nov. 14, 2022
(86) PCT No.: PCT/US2022/049841

§ 371 Date: May 3, 2024

Related U.S. Application Data
(60) Provisional application No. 63/283,773, filed on Nov. 29, 2021.

(51) Int. Cl. G01N 15/06

(52) U.S. Cl. CPC G01N 15/0606

(57) ABSTRACT

A metrology apparatus includes: a probe apparatus configured to produce a probe in a vicinity of an optical element that is in fluid communication with a gain medium of a gas discharge chamber and is exposed to one or more dust particles; a detection apparatus configured to detect an interaction between the probe and one or more dust particles, and to produce an output signal based on the detected interaction; and a processing apparatus configured to receive the output signal and to estimate a property of the one or more dust particles.

### CROSS REFERENCE TO RELATED APPLICATIONS

This application claims priority to U.S. Application No. 63/283,773, filed Nov. 29, 2021, titled METROLOGY APPARATUS AND METHOD, which is incorporated herein in its entirety by reference.

### TECHNICAL FIELD

The disclosed subject matter relates to a metrology apparatus for estimating one or more properties of dust particles in a gas discharge chamber of a deep ultraviolet light source.

### BACKGROUND

One kind of gas discharge light source used in photolithography is termed an excimer light source, or excimer laser. Typically, an excimer laser uses a combination of one or more noble gases, which can include argon, krypton, or xenon, and a reactive gas, which can include fluorine or chlorine. The excimer laser can create an excimer, a pseudo-molecule, under appropriate conditions of electrical simulation (energy supplied) and high pressure (of the gas mixture), the excimer only existing in an energized state. The excimer in an energized state gives rise to amplified light in the ultraviolet range. An excimer light source can use a single gas discharge chamber or multiple gas discharge chambers. When the excimer light source is performing, the excimer light source produces a deep ultraviolet (DUV) light beam. DUV light can include wavelengths from, for example, about 100 nanometers (nm) to about 400 nm.

The DUV light beam can be directed to a photolithography exposure apparatus or scanner, which is a machine that applies a desired pattern onto a target portion of a substrate such as a silicon wafer. The DUV light beam interacts with a projection optical system, which projects the DUV light beam through a mask onto the photoresist of the wafer. In this way, one or more layers of chip design is patterned onto the photoresist and the patterned wafer may then be subsequently processed such as by implanting or etching, for example.

### SUMMARY

In some general aspects, a metrology apparatus includes: a probe apparatus configured to produce a probe in the vicinity of an optical element that is in fluid communication with a gain medium of a gas discharge chamber and is exposed to one or more particles (such as dust particles); a detection apparatus configured to detect an interaction between the probe and one or more particles, and to produce an output signal based on the detected interaction; and a processing apparatus configured to receive the output signal and to estimate a property of the one or more particles.

Implementations can include one or more of the following features. For example, the probe apparatus can be an optical assembly and the probe can be a light sheet. The detection apparatus can be configured to detect the interaction by capturing light produced from the interaction between the light sheet and the one or more particles. The optical assembly can include a laser configured to produce a laser light sheet as the light sheet. The laser can be configured to produce light having a wavelength that is distinct from a wavelength of light produced from the gain medium in the gas discharge chamber. The detection apparatus can include a photodiode or a camera. An imaging plane of the photodiode or the camera can face the light sheet so that the extent of the light sheet is observable and imageable. The imaging plane of the photodiode or the camera can face a surface of the optical element facing an interior of the gas discharge chamber. A probing axis of the light sheet can lie in the imaging plane of the photodiode or the camera and one of: a long plane of the light sheet can be parallel with the imaging plane of the photodiode or the camera; the long plane of the light sheet can be perpendicular with the imaging plane of the photodiode or the camera; or the long plane of the light sheet can be arranged to be at an angle that is between parallel with and perpendicular with the imaging plane of the photodiode or the camera.

The light sheet can be directed along a path that is nonparallel with a plane along which an amplified light beam produced by the gain medium under the application of energy travels through the gas discharge chamber. The light sheet can be directed along a path that is adjacent to a surface of the optical element. The optical element can be a window of the gas discharge chamber that is configured to pass an amplified light beam between an interior of the gas discharge chamber that is hermetically controlled and filled with the gain medium and an exterior of the gas discharge chamber. The light sheet can be directed along a path that is adjacent to a surface of the window facing the interior of the gas discharge chamber. The light sheet can be directed along a path that is in the vicinity of a surface of the window facing the interior of the gas discharge chamber. The detection apparatus can be configured to capture light from the light sheet that is scattered or reflected from the one or more particles.

The processing apparatus can be configured to estimate the property of the one or more particles by estimating one or more of a number of the one or more particles, a location of the one or more particles, a density of the one or more particles, and a velocity of the one or more particles. The probe apparatus can produce the probe in the vicinity of the optical element and the detection apparatus can produce the output signal based on the detected interaction while the gas discharge chamber is producing an amplified light beam. The gas discharge chamber can include a gas containing a gain medium and electrodes for supplying energy to the gain medium such that the gain medium generates plasma that produces an amplified light beam when voltage is applied to the electrodes.

The probe apparatus and the detection apparatus can be arranged relative to (such as within or attached to) a housing that holds the optical element.

In other general aspects, an apparatus for a deep ultraviolet (DUV) gas discharge light source includes a metrology apparatus and an actuation apparatus. The metrology apparatus includes: a probe apparatus configured to produce a probe in a vicinity of an optical element that is in fluid communication with a gain medium of a gas discharge chamber and is exposed to one or more particles; a detection apparatus configured to detect an interaction between the probe and one or more particles, and to produce an output signal based on the detected interaction; and a processing apparatus configured to receive the output signal and to estimate a property of the one or more particles. The actuation apparatus is configured to receive the estimated property and adjust one or more features of the gas discharge light source based on the estimated property.

Implementations can include one or more of the following features. For example, the apparatus can include a control apparatus in communication with the processing apparatus and the actuation apparatus. The control apparatus can be configured to analyze the estimated property, and analyze performance of the gas discharge chamber based on the analysis of the estimated property.

The control apparatus can be configured to predict a lifetime of the optical element and/or the gas discharge chamber. The actuation apparatus can be configured to adjust one or more features of a dust particle trap system.

The particles can include dust particles produced from the gain medium in the gas discharge chamber. The gain medium can include a fluoride and the dust particles can include metal fluoride particles. The gain medium can include argon fluoride, krypton fluoride, or xenon chloride.

The metrology apparatus can be associated with a power ring amplifier of the DUV gas discharge light source and the optical element can be a window of the gas discharge chamber of the power ring amplifier. The probe can be arranged in the vicinity of the window of the gas discharge chamber of the power ring amplifier that is in fluid communication with a gain medium and is exposed to one or more particles. The window of the gas discharge chamber of the power ring amplifier can be the window at the output side of the gas discharge chamber of the power ring amplifier. The window can be made of a crystalline structure configured to transmit light having a wavelength in the DUV range. The window can be made of calcium fluoride, magnesium fluoride, or fused silica.

The probe apparatus can be an optical assembly including a laser configured to produce a laser light sheet as the probe. The detection apparatus can configured to detect the interaction by capturing light produced from the interaction between the light sheet and the one or more particles.

The laser can be configured to produce light having a wavelength that is distinct from a wavelength of light produced from the gain medium in the gas discharge chamber. The detection apparatus can include a photodiode or a camera. The light sheet can be directed along a path that is nonparallel with a plane along which an amplified light beam produced by the gain medium under the application of energy travels through the gas discharge chamber. The light sheet can be directed along a path that is adjacent to a surface of the optical element.

In other general aspects, a metrology method includes: producing a probe in a vicinity of an optical element that is in fluid communication with a gain medium of a gas discharge chamber and is exposed to one or more dust particles; detecting an interaction between the produced probe and one or more dust particles; producing an output signal based on the detected interaction; and estimating a property of the one or more dust particles based on the output signal.

Implementations can include one or more of the following features. For example, the probe can be produced by producing a laser light sheet and the interaction can be detected by capturing light produced from the interaction between the light sheet and the one or more dust particles. The laser light sheet can have a wavelength that is distinct from a wavelength of light produced from the gain medium in the gas discharge chamber. The light produced from the interaction between the light sheet and the one or more dust particles can be captured by capturing light from the laser light sheet that is scattered or reflected from the one or more dust particles. The light from the laser light sheet that is scattered or reflected from the one or more dust particles can be captured by generating a potential difference at an exposure surface or generating an two-dimensional image at an exposure surface, the exposure surface receiving the scattered or reflected light from the laser light sheet. The laser light sheet can be produced by directing the laser light sheet along a path that is nonparallel with a plane along which an amplified light beam produced by the gain medium under the application of energy travels through the gas discharge chamber. The laser light sheet can be directed along the path by directing the laser light sheet along a path that is adjacent to a surface of the optical element.

The property of the one or more dust particles can be estimated by estimating one or more of a number of the one or more dust particles, a location of the one or more dust particles, a density of the one or more dust particles, and a velocity of the one or more dust particles. The probe can be produced in the vicinity of the optical element and the output signal can be produced based on the detected interaction while the gas discharge chamber is producing an amplified light beam.

### DESCRIPTION OF DRAWINGS

FIG. 1 is a block diagram of a metrology apparatus arranged relative to a gas discharge chamber of a light source to estimate a property of one or more particles that are in a vicinity of an optical element within a cavity of the gas discharge chamber;

FIG. 2A is a schematic illustration of an implementation of a probe apparatus that includes a light sheet and a detection apparatus of the metrology apparatus of FIG. 1;

FIG. 2B is a schematic illustration showing an implementation of the relative placement between the light sheet and an imaging plane of the detection apparatus;

FIG. 2C is a schematic illustration showing another implementation of the relative placement between the light sheet and an imaging plane of the detection apparatus;

FIG. 3A is a schematic illustration of an implementation of the probe apparatus that produces a light sheet as a probe and a detection apparatus placed relative to the optical element;

FIG. 3B is a schematic illustration of a sensor of a camera of an implementation of the detection apparatus of FIG. 3A;

FIG. 4 is a block diagram of an implementation of the gas discharge chamber and the metrology apparatus of FIG. 1 as a part of a deep ultraviolet (DUV) light source;

FIG. 5 is a block diagram of an implementation of a processing apparatus of the metrology apparatus of FIG. 1;

FIG. 6 is a block diagram of a two-stage light source that is an implementation of the DUV light source of FIG. 4;

FIG. 7 is a cross-sectional view of an implementation of a power amplifier gas discharge chamber of the two-stage light source of FIG. 6, in which a metrology apparatus is arranged relative to a window of the power amplifier gas discharge chamber and the probe is a light sheet traveling along a probing axis that is nonparallel with a working light beam;

FIG. 8A is a close-up detail of a cross-sectional view of the window of the power amplifier gas discharge chamber of FIG. 7 taken along the probing axis of the probing light sheet;

FIG. 8B is a close-up detail of a cross-sectional view of the window of FIG. 8A taken along the 8B-8B plane;

FIG. 9A is a close-up detail of a cross-sectional view of the window of the power amplifier gas discharge chamber of FIG. 7 taken along the probing axis of the probing light sheet and showing another possible location for the probing light sheet;

FIG. 9B is a close-up detail of a cross-sectional view of the window of the power amplifier gas discharge chamber of FIG. 7 taken along the probing axis of the probing light sheet and showing another possible location for the probing light sheet;

FIG. 10A is a schematic illustration of an implementation of the probe apparatus that produces a light sheet as a probe and a detection apparatus placed relative to the optical element such that the imaging plane is distinct from the imaging plane of the detection apparatus of FIG. 3A;

FIG. 10B is a schematic illustration of a sensor of a camera of an implementation of the detection apparatus of FIG. 10A;

FIG. 11 is a flow chart of a procedure performed by the metrology apparatus;

FIG. 12 is an example of an image that is captured at a camera of the detection apparatus of FIGS. 3A and 3B;

FIG. 13 is an example of a composite image that is captured at a camera of the detection apparatus of FIGS. 3A and 3B, the composite image showing the flow path or trajectories of dust particles over time;

FIG. 14A is an example of an image that is captured at a camera of the detection apparatus of FIGS. 3A and 3B taken at time T1;

FIG. 14B is an example of an image that is captured at a camera of the detection apparatus of FIGS. 3A and 3B taken at time T2 after time T1 and showing the regions of interest that were captured at time T1; and

FIG. 14C is an example of an image that is captured at a camera of the detection apparatus of FIGS. 3A and 3B taken at time T3 after time T2 and showing the regions of interest that were captured at time T2 and T1.

### DESCRIPTION

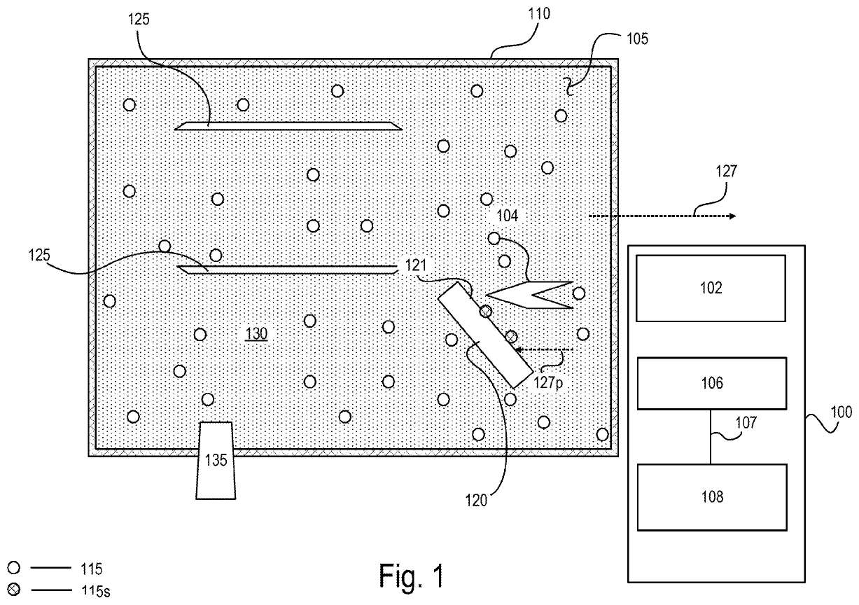

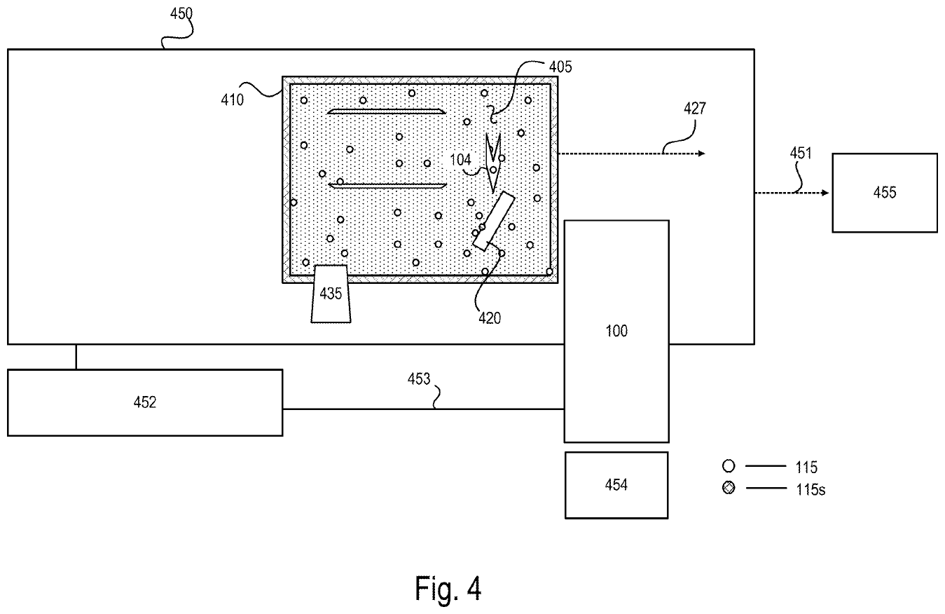

Referring to FIG. 1, a metrology apparatus 100 is arranged relative to a cavity 105 of a gas discharge chamber 110. The metrology apparatus 100 is configured to estimate a property of one or more particles 115 (such as may be dust particles) that flow in the vicinity of an optical element 120 inside the cavity 105 of the gas discharge chamber 110. For example, the metrology apparatus 100 can detect and/or track one or more of these dust particles 115. The optical element 120 is an element that includes a surface that is in fluid communication with the cavity 105 of the gas discharge chamber 110 and therefore can become exposed to the dust particles 115. The optical element 120 is an element that interacts optically with a light beam 127p that is either an amplified light beam 127 produced by the gas discharge chamber 110 or a pre-cursor light beam that becomes the amplified light beam 127 (for example, after interacting with other components or elements of the gas discharge chamber 110). For example, the optical element 120 can be a window of the gas discharge chamber 110 or an optical element used in various metrology operations. The metrology apparatus 100 is able to estimate the property of the one or more particles 115 while the gas discharge chamber 110 produces (or is producing) the amplified light beam 127 for use by an output apparatus, such as shown in FIG. 4 below. Thus, the metrology apparatus 100 operates in real time and its operation does not cause disruption to the operation of the gas discharge chamber 110 (or the light source in which the gas discharge chamber 110 is used, such as shown in FIG. 4).

During operation of the gas discharge chamber 110, a gain medium 130 (placed in an optical resonator) is pumped with short (for example, nanosecond) current pulses in a high-voltage electric discharge from an energy source 125 (such as a pair of electrodes), which creates a plasma that leads to optical amplification, and the amplified light beam 127 having a wavelength in the ultraviolet range (for example, deep ultraviolet or DUV range) is produced and output from the gas discharge chamber 110. The gain medium 130 is a gas mixture that usually contains a noble gas (such as argon, krypton, or xenon) and a halogen (such as fluorine or chlorine) apart from a buffer gas. Thus, for example, the gain medium 130 can include argon fluoride (ArF), krypton fluoride (KrF), or xenon chloride (XeCl). If the gain medium 130 includes argon fluoride (ArF), then the wavelength of the amplified light beam 127 is about 193 nm. The electrodes 125 erode during normal operation, and such erosion can lead to the generation of metal fluoride (or metal chloride if chloride is the halogen) particles. Such particles produced due to erosion are referred to herein as the dust particles 115 but could alternatively be described simply as particles.

Typically, these dust particles 115 would not get close to the optical element 120 because the gas discharge chamber 110 is fitted with a dust particle trap system 135. The dust particle trap system 135 provides a cleaning purge gas that is configured to push the purge gas along a path relative to the optical element 120 to prevent or reduce the chance of the dust particles 115 coming in contact with the optical element 120. For example, the dust particle trap system 135 can be a metal fluoride trap (MFT), which can use a mechanical mesh and electrostatic force to trap particles of metal fluoride or other particles. In some implementations, as a portion of the gas discharge gain medium passes through the MFT, metal fluoride dust in the contaminated gas discharge gain medium is adsorbed in a trap filter and any remaining particles are collected by an electrostatic precipitator. For example, certain MFTs have been previously described in U.S. Pat. No. 6,240,117, issued May 29, 2001 and U.S. Pat. No. 7,819,945, issued Oct. 26, 2010, which are hereby incorporated by reference herein in their entireties.

Nevertheless, even with the dust particle trap system 135, there are certain circumstances when the dust particles 115 can still access (and contaminate) the optical element 120. For example, contamination can occur during a gas refill procedure (in which the gain medium 130 is replaced or refilled). As another example, contamination can occur during normal operation of the gas discharge chamber 110 if the dust particle trap system 135 leaks or is full (of the dust particles 115). If a significant number of dust particles 115 deposit on the optical element 120, damage can be caused to the optical element 120. Because the optical element 120 interacts with the light beam 127, any dust particles 115 on a surface 121 of the optical element 120 (such as the dust particles 115s) absorb energy from the light beam 127 as well, and this causes the dust particles 115s at the surface of the optical element 120 to heat up, and possibly become welded to the surface of the optical element.

Damage to the surface 121 of the optical element 120 can become a critical issue especially with the need to extend the lifetime of the gas discharge chamber 110 and also to increase energy in the amplified light beam 127.

The metrology apparatus 100 is able to track and/or detect these dust particles 115/115s that flow near the optical element 120. The information about the dust particles 115/115s that is obtained by the metrology apparatus 100 can be used to determine whether a performance issue with the gas discharge chamber 110 is due to the optical element 120 becoming contaminated with the dust particles 115/115s. Moreover, the metrology apparatus 100 enables the tracking and/or detection of these dust particles 115/115s and also enables the determination relating to the gas discharge chamber 110 performance without requiring the cessation of operation of the gas discharge chamber 110, without requiring the disassembly of the gas discharge chamber 110, and without the need to remove the optical element 120 from the cavity 105 and directly examine the optical element 120.

The metrology apparatus 100 includes a probe apparatus 102, a detection apparatus 106, and a processing apparatus 108. The probe apparatus 102 is configured to produce a probe 104 in a vicinity of the optical element 120. The probe 104 is in the vicinity of the optical element 120 if it is positioned either adjacent to or neighboring the optical element 120 or is close enough to the optical element 120 that it is possible to estimate the property of the dust particles 115 that impact operation of the optical element 120. Moreover, the probe 104 is in the vicinity of the optical element 120 if there is a pathway for dust particles 115 to travel between the probe 104 and the optical element 120 and there are no obstructions between the dust particles 115 and the probe 104. The probe 104 interacts with those dust particles 115 that are intercepted by the probe 104. The detection apparatus 106 is configured to detect this interaction between the probe 104 and one or more of the dust particles 115. The detection apparatus 106 produces an output signal 107 based on this detected interaction. The processing apparatus 108 is configured to receive the output signal 107 and estimate the property of the one or more dust particles 115.

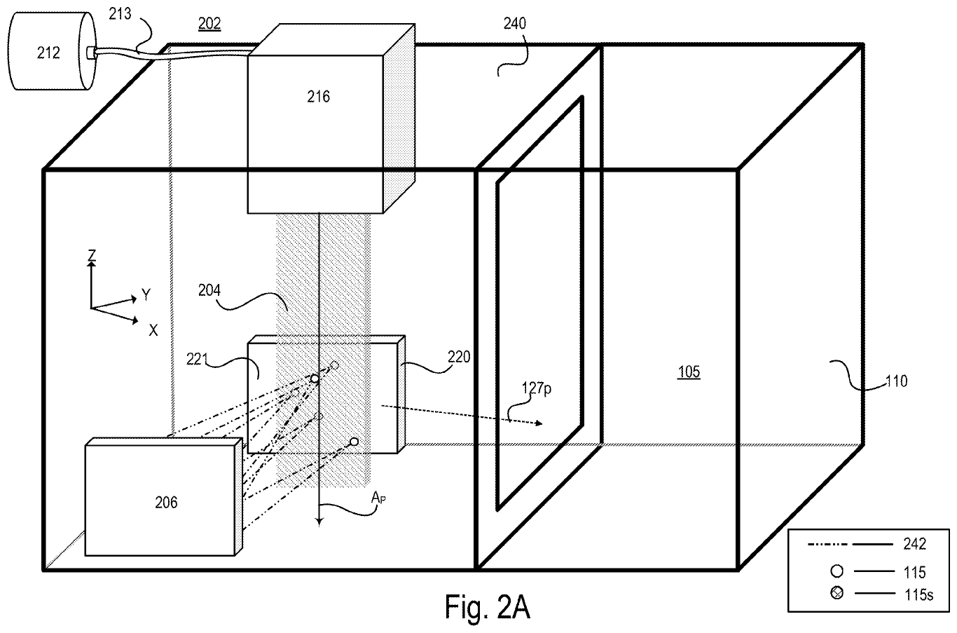

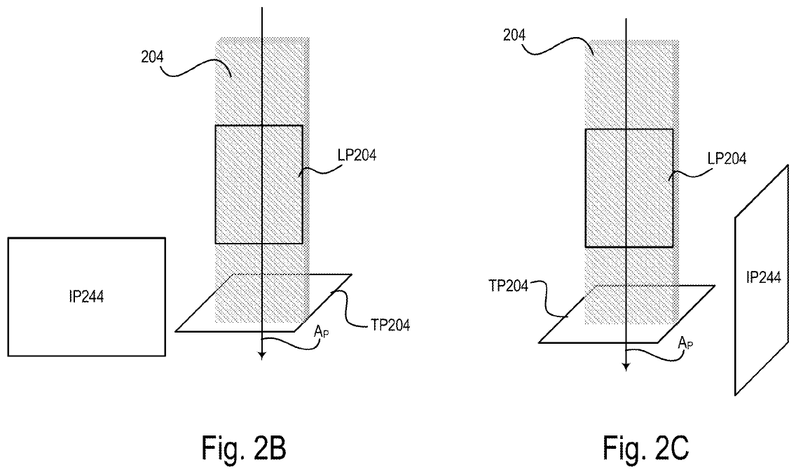

Referring to FIG. 2A, an implementation 202 of the probe apparatus 102 produces a light sheet 204 as the probe 104. The probe apparatus 202 is an optical assembly that includes a light source 212 configured to produce a light beam that is optically modified by optical components 216 that direct and shape the light beam into the light sheet 204. In one particular example, the light source 212 is a laser such as a He—Ne laser, a Nd/YAG laser, or any laser or laser source having a wavelength that is distinct from the wavelength of the light beam 127. The output of the light source 212 is a light beam or laser beam and the laser beam can be directed through an optical fiber 213 toward the optical components 216, which are positioned or arranged along a path toward the optical element 220. The optical components 216 can include one or more mirrors that redirect the light beam and one or more windows through which the light beam travels. One or more of the optical components 216 (such as windows) can be used to hermetically seal the optical components 216 to the gas discharge chamber 110 of FIG. 1. Or, the optical components 216 can be mounted in a housing 240 that is hermetically sealed to the gas discharge chamber 110. In this way, the light beam from the light source 212 can be created outside the cavity 105 and then be transported via the optical components 216 into an area that is fluidly connected or inside of the cavity 105. Additionally, the optical element 220 can be mounted in the housing 240 that is hermetically sealed to the gas discharge chamber 110 such that the optical element 220 is exposed to the gain medium 130. In this case, the windows of the optical components 216 can hermetically seal the housing 240. The optical components 216 also include a cylindrical lens that converts the light beam into the light sheet 204 that has an extent along a first transverse direction that is much greater than an extent along a second transverse direction, where the transverse direction is perpendicular to the direction along which the light sheet 204 travels. The optical component 216 windows can be made of CaF₂. In this way, the probe apparatus 202 is retro-fitted into the housing 240 of the optical element 220.

The light sheet 204 is directed along a path that is defined by the probing axis A_{P}. The probing axis A_{P} should be nonparallel with a plane or path along which the light beam 127 travels through the gas discharge chamber 110. In this way, the light sheet 204 will not interfere with the light beam 127 since it is not able to follow the same path that the light beam 127 takes through the gas discharge chamber 110. For example, the light beam 127 travels along the XY plane of the chamber 110, and the probing axis A_{P} is generally aligned with the Z axis. In the implementation shown, the light sheet 204 is directed along a path that is adjacent to the surface 221 of the optical element 220 that is in fluid communication with the cavity 105 of the gas discharge chamber 110.

An implementation 206 of the detection apparatus 106 is shown in FIG. 2A. The detection apparatus 206 is configured to detect light 242 produced from the interaction between the light sheet 204 and the one or more dust particles 115. The light 242 can be light from the light sheet 204 that is scattered, reflected, or deflected by the dust particle 115, and directed along the field of view of the detection apparatus 206. The detection apparatus 206 can include a photodiode or a camera. A photodiode measures an intensity of the light 242 and converts this light energy into a current.

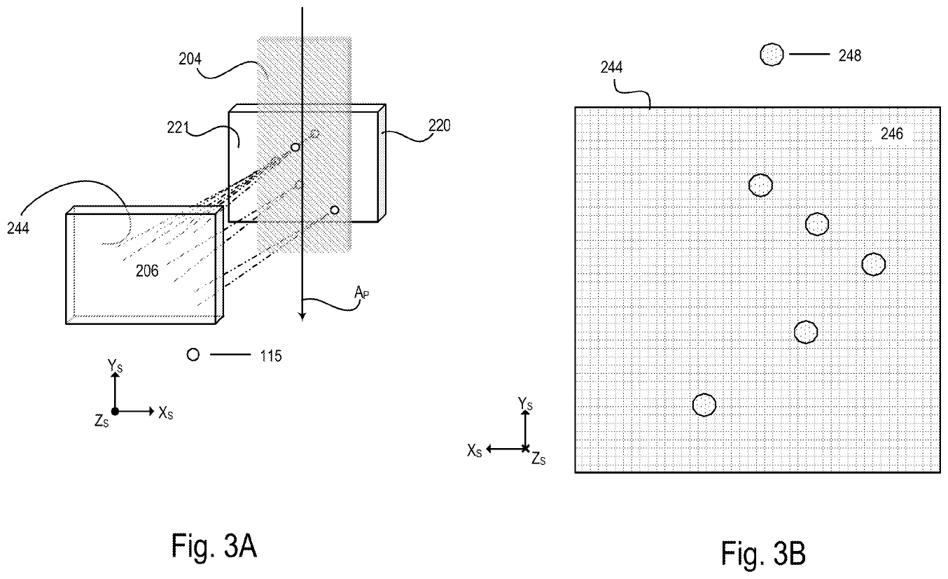

On the other hand, and with reference to FIGS. 3A and 3B, a sensor 244 of a camera captures a two-dimensional visual image 246 of the field of view facing the light sheet 204 and is thus able to visualize the dust particles 115 in the XY plane of the sensor 244 in two dimensions. In particular, the dust particles 115 show up in the image as shapes (or regions of interest) 248 that correspond to a change in intensity at the pixels underlying the shapes 248 relative to the other pixels in the image 246.

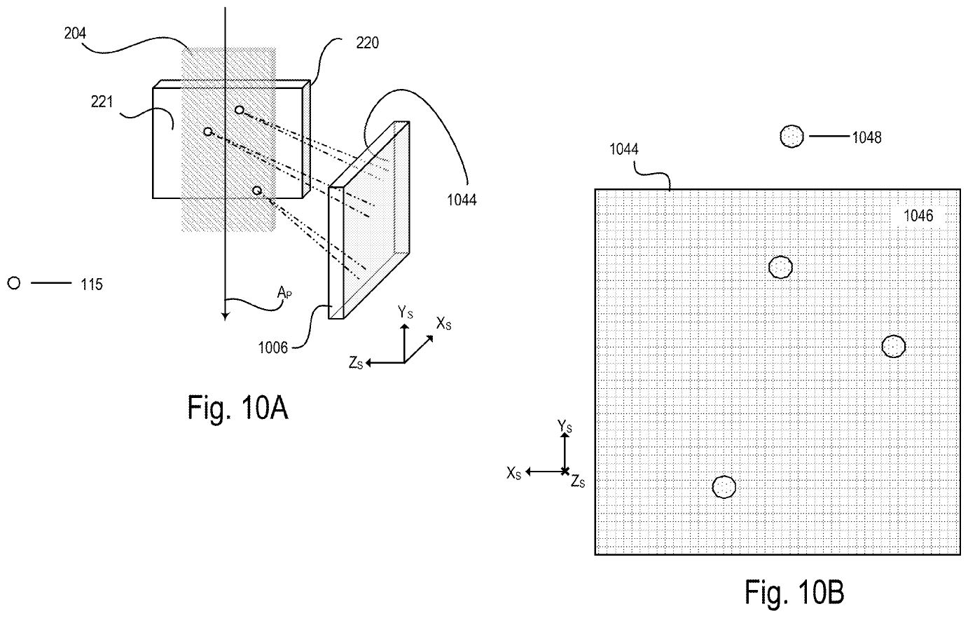

In either scenario (in which the detection apparatus 206 includes a photodiode or a camera), and now referring back to FIGS. 2B and 2C, an imaging plane IP244 of such photodiode or camera should face the light sheet 204. In particular, the imaging plane IP244 of the photodiode or the camera can be perpendicular with a transverse plane TP204 of the light sheet 204, in which the transverse plane TP204 of the light sheet 204 is the plane of the light sheet 204 that is perpendicular to the probing axis A_{P}. Thus, in some implementations, the imaging plane IP244 of the photodiode or the camera is parallel with the probing axis A_{P}, such that the probing axis A_{P} lies in the imaging plane IP244 of the photodiode or the camera. If the light sheet 204 has a long extent that is defined by a long plane LP204 that is perpendicular with the transverse plane TP204 of the light sheet 204, then the imaging plane IP244 of the photodiode or the camera can be parallel with the long plane LP204 of the light sheet 204, as shown in FIG. 2B, or it can be perpendicular with the long plane LP204 of the light sheet 204, as shown in FIG. 2C and also shown in FIG. 10A, or it can be along any direction between these two extremes.

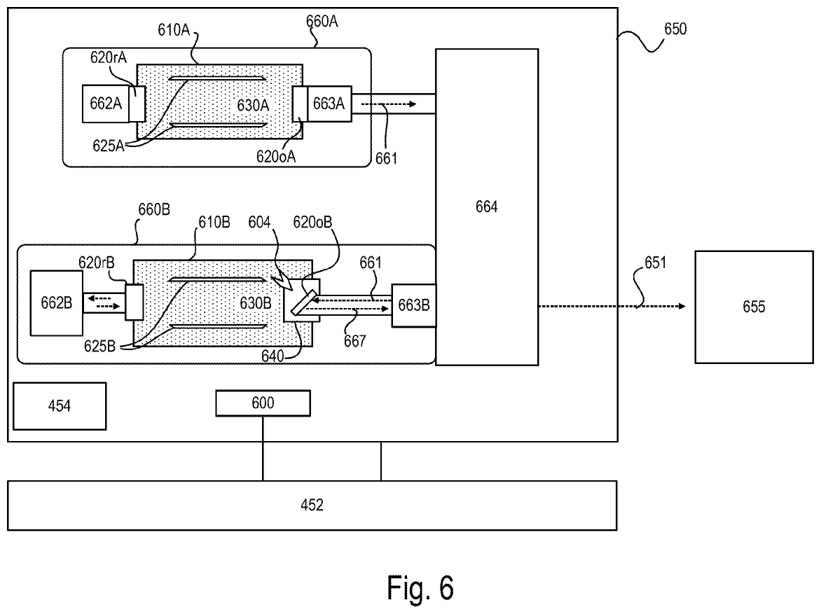

Referring to FIG. 4, an implementation 410 of the gas discharge chamber 110 is shown as a part of a deep ultraviolet (DUV) gas discharge light source 450, the gas discharge chamber 410 producing the amplified light beam 427 (which corresponds to the amplified light beam 127). The light source 450 can include other apparatuses and optical elements not shown in FIG. 4. For example, an implementation 650 of a two-stage light source 450 is shown in FIG. 6. Moreover, the light source 450 outputs a working light beam 451 for use by an output apparatus 455, which can be a photolithography exposure apparatus. The working light beam 451 can correspond to the amplified light beam 427, depending on the location of the gas discharge chamber 410 within the light source 450. Or, the amplified light beam 427 can be directed through other optical apparatuses and elements within the light source 450 before forming the working light beam 451 for use by the output apparatus 455. The metrology apparatus 100 communicates with an actuation apparatus 452, which receives the estimated property 453 relating to the one or more particles 115 that flow in the vicinity of the optical element 420 inside the cavity 405 of the gas discharge chamber 410. The actuation apparatus 452 is configured to adjust one or more features of the DUV gas discharge light source 450 based on the estimated property 453. For example, the actuation apparatus 452 can be configured to adjust one or more features of the dust particle trap system 435.

Additionally, a control apparatus 454 can be in communication with the metrology apparatus 100 (and specifically the processing apparatus 108) and the actuation apparatus 452. The control apparatus 454 can be privy to more information about operation of the light source 450 than the processing apparatus 108. In this way, the control apparatus 454 can analyze the estimated property 453 (output from the processing apparatus 108 of metrology apparatus 100) and further analyze the performance of the gas discharge chamber 410 and/or the light source 450 based on the estimated property 453. For example, the control apparatus 454 can be configured to predict a lifetime of the optical element 420 and/or the gas discharge chamber 410.

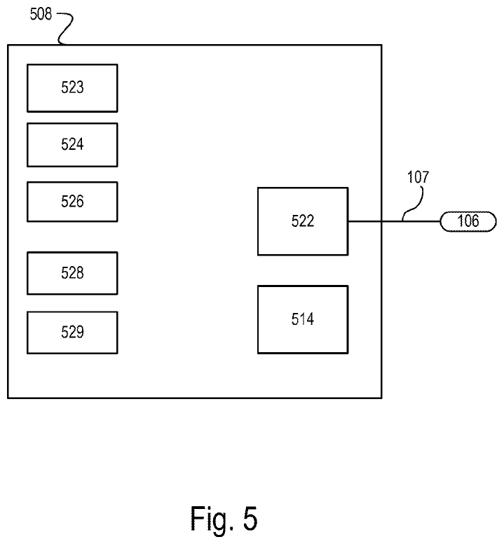

Referring to FIG. 5, an implementation 508 of the processing apparatus 108 is shown. The processing apparatus 508 includes a signal processing module 522 that is configured to receive the output signal 107 from the detection apparatus 106.

If the output signal 107 is provided by the sensor 244 of the detection apparatus 206, then the signal processing module 522 receives the two-dimensional representations (the images) from the detection apparatus 206, and performs processing on the images. To this end, the signal processing module 522 can include various sub-modules that are configured to perform various types of analysis on the images. For example, the signal processing module 522 can include an input sub-module that receives the images from the detection apparatus 206 and converts the data into a format suitable for processing. The signal processing module 522 can include a pre-processing sub-module that prepares the images from the detection apparatus 206 (for example, removing background noise, filtering the images, and gain compensation). The signal processing module 522 can include an image sub-module that processes the image data such as identifying one or more regions of interest (ROIs) within an image, where each ROI is one of the shapes 248 that correspond to a location of the dust particle 115. The image sub-module can also calculate properties of each ROI such as, for example, an area of each ROI in the image and a centroid of each ROI. The analysis signal processing module 522 can include an output sub-module that prepares the calculated data (such as the area and centroid of the ROIs) for output.

If the detection apparatus 106 includes a photodiode, then output signal 107 is provided by the photodiode, and the output signal 107 is a voltage signal related to a current produced from the detected light at the photodiode of the detection apparatus 106. Generally, the signal processing module 522 analyzes the output signal 107 from the photodiode. For example, the signal processing module 522 can analyze a set of time stamps corresponding to how each dust particle 115 interacts with the probing light sheet 204, can determine whether an amplitude of the output signal 107 is greater than a threshold value, can determine a size (such as an area) of the output signal 107 that is greater than the threshold value, and/or can look at the start and end times at which the output signal 107 crosses the threshold value.

The processing apparatus 508 can also include or have access to one or more programmable processors 523, and one or more computer program products 524 tangibly embodied in a machine-readable storage device for execution by a programmable processor. The one or more programmable processors 523 can each execute a program of instructions to perform desired functions by operating on input data and generating appropriate output. Generally, the processor 523 receives instructions and data from memory 526. The memory 526 can be read-only memory and/or random-access memory. Storage devices suitable for tangibly embodying computer program instructions and data include all forms of non-volatile memory, including, by way of example, semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially designed ASICs (application-specific integrated circuits). The processing apparatus 508 can also include one or more input devices 528 (such as a keyboard, touch screen, microphone, mouse, hand-held input device, etc.) and one or more output devices 529 (such as speakers and monitors).

Additionally, if the metrology apparatus 100 is in communication with the actuation apparatus 452 (FIG. 4), then the processing apparatus 508 also includes an actuation module 514 in communication with the actuation apparatus 452 that is in communication with the DUV light source 450. The actuation module 514 can be within the processing apparatus 508 (as shown in FIG. 5) or it can be integrated within the actuation apparatus 452.

The modules within the processing apparatus 508 (such as the signal processing module 522 and the actuation module 514) can each include their own digital electronic circuitry, computer hardware, firmware, and software as well as dedicated memory, input and output devices, programmable processors, and computer program products. Likewise, any one or more of the modules 522, 514 can access and use the memory 526, the one or more input devices 528, the one or more output devices 529, the one or more programmable processors 523, and one or more computer program products 524.

Although the processing apparatus 508 is shown as a separate and complete unit, it is possible for each of its components and modules to be separate units. Moreover, the processing apparatus 508 can include other components, such as dedicated memory, input/output devices, processors, and computer program products, not shown in FIG. 5. Or the processing apparatus 508 can be integrated with the control apparatus 454.

Referring to FIG. 6, as mentioned above, the light source 450 can be a two-stage light source 650. The light source 650 includes a master oscillator 660A as its first stage and a power amplifier 660B as its second stage. The master oscillator 660A includes a master oscillator gas discharge chamber 610A and the power amplifier 660B includes a power amplifier gas discharge chamber 610B. The master oscillator gas discharge chamber 610A includes as the energy source two elongated electrodes 625A that provide a source of pulsed energy to a gain medium 630A within the chamber 610A. The power amplifier gas discharge chamber 610B includes as the energy source two elongated electrodes 625B that provide a source of pulsed energy to a gain medium 630B within the chamber 610B.

The master oscillator 660A provides a pulsed amplified light beam (called a seed light beam) 661 to the power amplifier 660B. The master oscillator gas discharge chamber 610A houses the gain medium 630A in which amplification occurs and the master oscillator 660A includes an optical feedback mechanism such as an optical resonator. The optical resonator is formed between a spectral optical system 662A on one side of the master oscillator gas discharge chamber 610A and an output coupler 663A on a second side of the master oscillator gas discharge chamber 610A. The power amplifier gas discharge chamber 610B houses the gain medium 630B in which amplification occurs when seeded with the seed light beam 661 from the master oscillator 660A. If the power amplifier 660B is designed as a regenerative ring resonator then it is described as a power ring amplifier, and in this case, enough optical feedback can be provided from the ring design. The power amplifier 660B can also include a beam return (such as a reflector) 662B that returns (via reflection, for example) the light beam back into the power amplifier gas discharge chamber 610B to form a circulating and looped path (in which the input into the ring amplifier intersects the output out of the ring amplifier) and also an output coupler 663B for inputting the seed light beam 661 and outputting an amplified light beam 667. The working light beam 651 that is supplied to the output apparatus can correspond to the amplified light beam 667 output from the power amplifier 660B and also additionally modified by other optical components 664 such as beam directing and redirecting and pulse stretching optics.

The gain medium 630A, 630B used in the respective discharge chambers 610A, 610B can be a combination of suitable gases for producing the amplified light beam around the required wavelengths, bandwidth, and energy. For example, as discussed above, the gain medium 630A, 630B can include argon fluoride (ArF), which emits light at a wavelength of about 193 nm, or krypton fluoride (KrF), which emits light at a wavelength of about 248 nm.

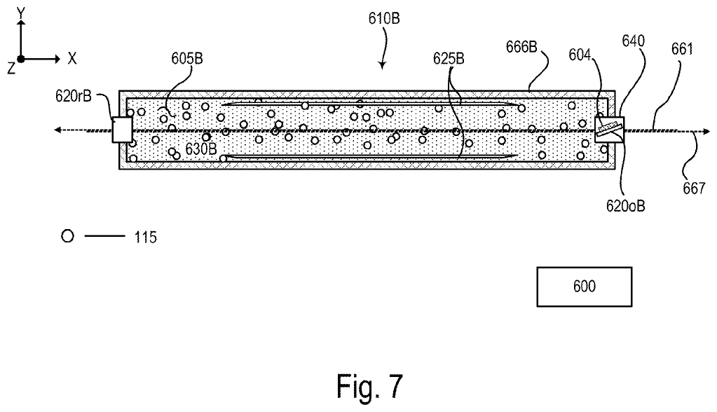

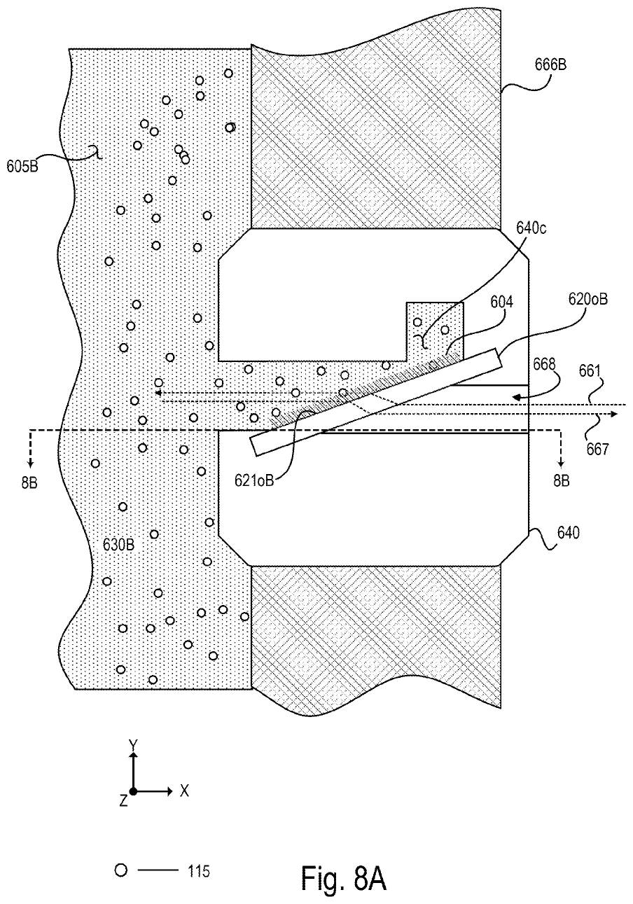

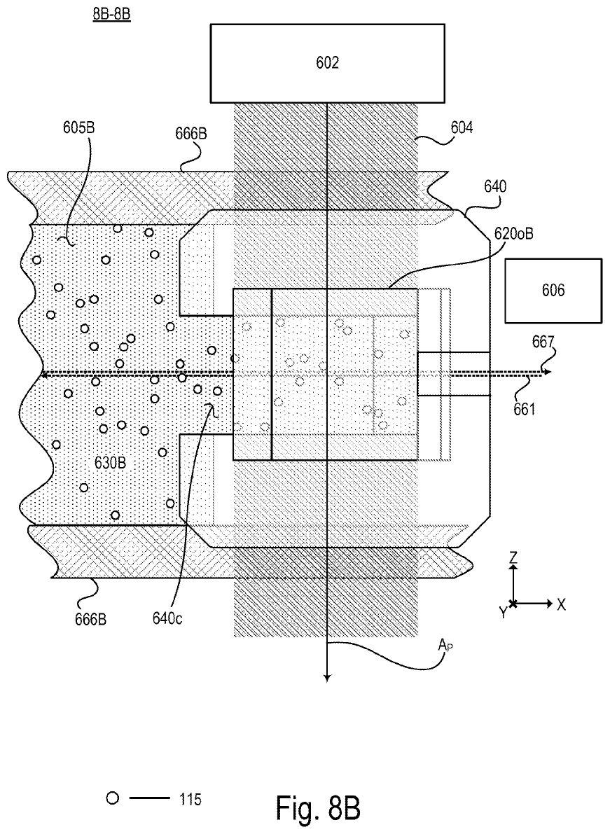

As discussed above, the metrology apparatus 100 can be associated with the gas discharge chamber 110. In the light source 650, an implementation 600 of the metrology apparatus 100 can be associated with either or both of the gas discharge chambers 610A, 610B. In one particular implementation, as shown in FIG. 6 and detailed in FIGS. 7-8B, the metrology apparatus 600 is associated with the power amplifier gas discharge chamber 610B and specifically associated with an optical element in the form of a window 620oB placed at the input/output side of the chamber 610B. In other implementations, the metrology apparatus 600 is associated with windows at other locations, or additional instances of the metrology apparatus is associated with additional windows at other locations within the light source 650. For example, a metrology apparatus 600 can be associated with a window 620rB that is placed at the other side of the power amplifier discharge chamber 610B, a window 620oA that is placed as the output side of the master oscillator discharge chamber 610A, or a window 620rA that is placed at the side of the master oscillator discharge chamber 610A facing the spectral optical system 662A. The windows 620oA, 620rA, 620oB, 620rB are made of a material that is compatible with the gain media 630A, 630B, respectively. Additionally, the windows 620oA, 620rA, 620oB, 620rB are made of a material that is able to transmit light that will be produced by the gain media 630A, 630B. Thus, in this example, since the light that is produced is in the DUV range, the windows 620oA, 620rA, 620oB, 620rB must transmit light having a wavelength in the DUV range. In some implementations, the windows 620oA, 620rA, 620oB, 620rB are made of a crystalline structure. For example, the windows 620oA, 620rA, 620oB, 620rB can be made of calcium fluoride, magnesium fluoride, or fused silica.

Referring to FIGS. 7-8B, the metrology apparatus 600 is associated with the power amplifier gas discharge chamber 610B and specifically with the window 620oB placed at the input/output side of the chamber 610B. The window 620oB is fixed to a wall 666B of the chamber 610B and within a window housing 640. The window housing 640 performs two functions: it fixes the window 620oB in place and it hermetically seals the window 620oB to the wall 666B such that the gas discharge chamber 610B remains hermetically sealed and retains the gain medium 630B. The window 620oB is configured to pass the seed light beam 661 into the cavity 605B of the chamber 610B and also is configured to pass the output amplified light beam 667.

The window housing 640 and the arrangement of the window 620oB are shown in more detail in FIGS. 8A and 8B. In this implementation, the probe is a light sheet 604 that is directed along a path that is adjacent to the surface 621oB of the window 620oB that faces the cavity 605B of the chamber 610B. The housing 640 includes a housing cavity 640c that is in fluid communication with the cavity 605B of the chamber 610B. Moreover, an optical path is defined within a passageway 668 of the housing 640 at the other side of the window 620oB. The passageway 668 enables the passage of the light beams 661, 667 through the window 620oB and into and out of, respectively, the cavity 605B of the chamber 610B. The light beams 661, 667 generally travel in an XY plane of the power amplifier gas discharge chamber 610B. This means that the light beams 661, 667 are generally not configured to move along the Z axis of the chamber 610B. As mentioned above, the metrology apparatus 600 operates while the gas discharge chamber 610B is producing the amplified light beam 667; thus, the light sheet 604 is directed in a manner that it will be in the vicinity of the window 620oB simultaneously with the passage of the light beams 661, 667 through the window 620oB. In order to prevent any optical interference between the light sheet 604 and the light beams 661, 667, the light sheet 604 is directed along a probing axis A_{P} (see FIG. 2A, for example) that is nonparallel with the XY plane along which the light beams 661, 667 travel through the power amplifier gas discharge chamber 610B. In one example, as shown in FIGS. 8A and 8B, the probing axis A_{P} is generally aligned with the Z axis and the light sheet 604 is directed along a path that is adjacent to the surface 621oB of the window 620oB that faces the cavity 605B of the gas discharge chamber 610B. Moreover, the wavelength of the light sheet 604 is distinct from the wavelength of the light beams 661, 667. In this way, the detection apparatus 606 is able to detect the interaction between the light sheet 604 and the one or more dust particles 115 even during the production of the amplified light beams 661, 667.

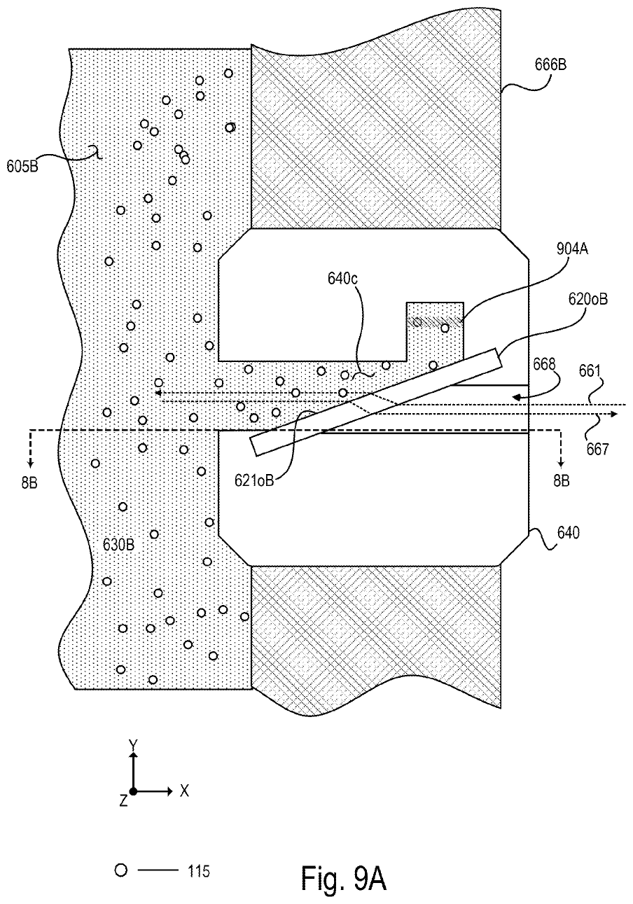

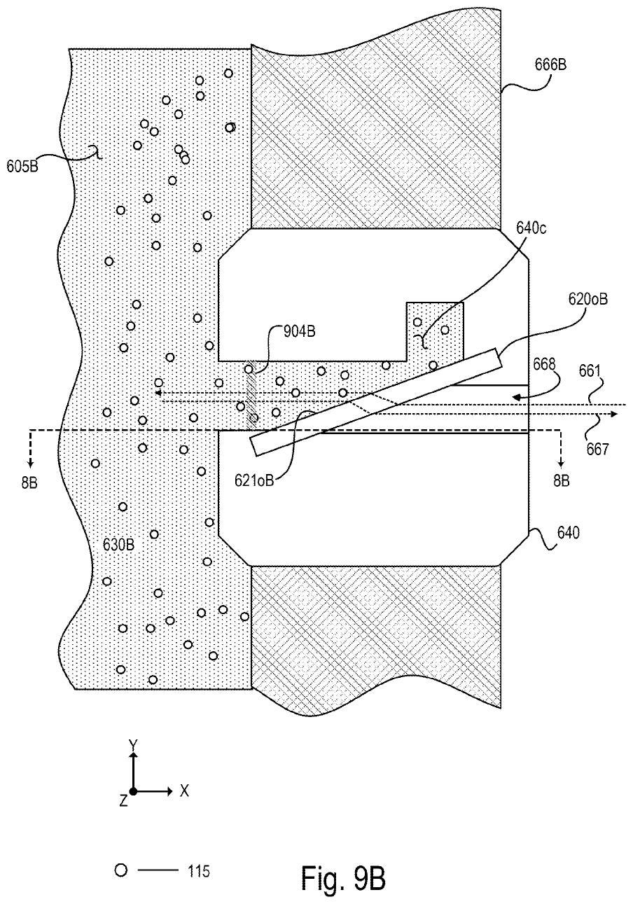

The light sheet 604 can be configured to pass through another region of the cavity 605B or the housing cavity 640c (which is fluidly communicating with the cavity 605B). For example, as shown in FIGS. 9A and 9B, respective light sheets 904A and 904B are positioned at other locations within the housing cavity 640c. Other positions for the light sheets 604, 904A, 904B are possible, as long as they are close enough to (in the vicinity of) the window 620oB to enable an accurate estimate of the number of dust particles 115 that come in contact with or are in the vicinity of, the window 620oB.

Referring to FIGS. 10A and 10B, an implementation 1006 of the detection apparatus 206 is arranged so that the imaging plane (the X_{S}Y_{S} plane) of the sensor 1044 is rotated relative to the imaging plane of the sensor 244 of the detection apparatus 206 shown in FIG. 2A. In both cases, the detection apparatus 206 and 1006 is arranged so that its imaging plane is facing and is able to image the full extent of the light sheet 204. This enables the detection apparatus 1006 to capture the two-dimensional visual image 1046 of the field of view facing the light sheet 204, and the dust particles 115 are visualized as shapes or regions of interest 1048 in the image 1046. The detection apparatus 206 can be arranged along any direction as long as the imaging plane (the X_{S}Y_{S} plane) of the sensor 244 is able to visualize the larger extent of the light sheet 204. Thus, the imaging plane (the X_{S}Y_{S} plane) of the sensor 244 should not be perpendicular to the probing axis A_{P}.

Referring to FIG. 11, a metrology procedure 1170 is performed. The metrology procedure 1170 can be performed by the metrology apparatus 100 associated with the gas discharge chamber 110. A probe 104 is produced in the vicinity of the optical element 120 (1172). The interaction between the probe 104 and one or more dust particles 115 is detected (1174). The output signal 107 is produced based on this detected interaction (1176). And, a property of the one or more dust particles 115 is estimated based on the output signal 107 (1178).

For example, the probe 104 can be produced (1172) by producing the light sheet (such as the light sheet 204) in the vicinity of the optical element 220. With reference to the implementation of FIGS. 7, 8A, 8B, the light sheet 604 is directed along the probing axis A_{P} that is nonparallel with the XY plane along with the working light beams 661, 667 travel through the gas discharge chamber 610B. Moreover, the light sheet 604 can be directed along a path that is adjacent to the surface 621oB of the optical element 620oB. The probe 104 is produced (1172) while the gas discharge chamber 110 is operating to produce the working light beam 127.

In the example of FIG. 2A, the interaction is detected (1174) by capturing the light 242 that is produced from the interaction between the light sheet 204 and the one or more dust particles 115. The light 242 that is captured (for example, by the detection apparatus 206 at step 1174) can be light from the light sheet 204 that is scattered or reflected from the one or more dust particles 115. Moreover, the light 242 can be captured by a photodiode at the detection apparatus 206, or by a camera such as with the sensor 244 of the detection apparatus 206.

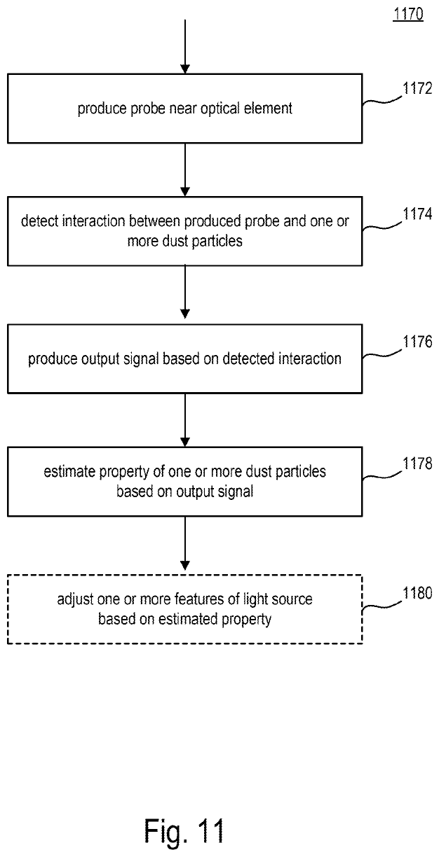

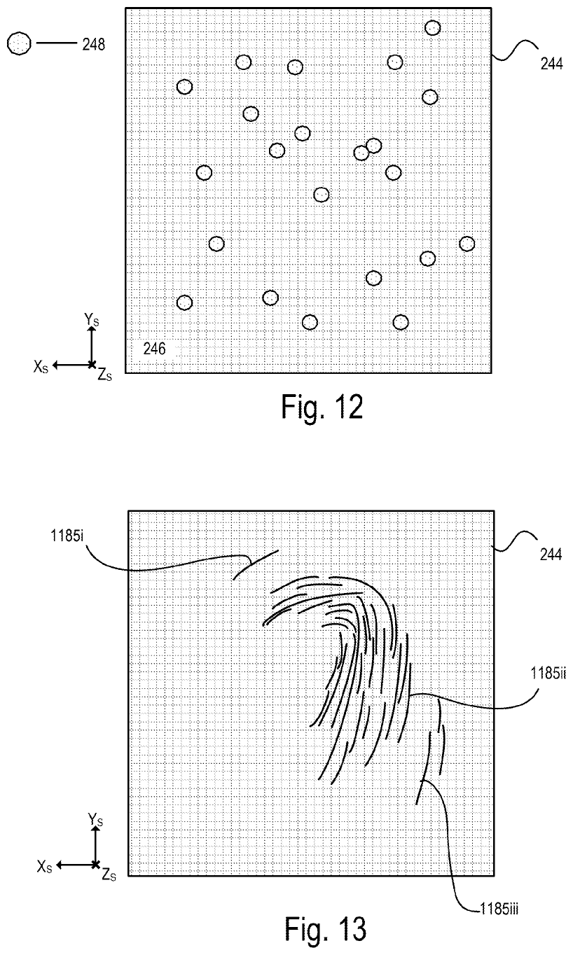

As discussed above, in the implementation in which the detection apparatus 106 includes a two-dimensional imaging device such as a camera with a sensor 244, the output signal 107 that is produced (1176) is a two-dimensional representation or image 246 of the field of view of the sensor 244. Referring to FIG. 12, regions of interest or shapes 248 are displayed on the image 246. From this data, for example, the processing apparatus 108 is able to estimate or count the number of dust particles 115 that exist within the vicinity of the optical element 120 (over a period of time) (1178). Additionally, because the location of the light sheet 204 within the cavity 105 (or cavity 605B, 640c) is known, the processing apparatus 108 is also able to estimate the location of the one or more dust particles 115. The processing apparatus 108 can also be able to estimate or count the number of dust particles 115 that exist within a particular area in the vicinity of the optical element 120 at one instance in time (a density) or over a period of time (a changing density) (1178).

The processing apparatus 108 can continuously store the locations of the one or more dust particles 115 within memory 523, and use the stored locations to track the path of the dust particles and also the velocity (the speed and direction) of the dust particles 115 in the vicinity of the optical element 220 over time (1178). For example, and with reference to FIG. 13, processing apparatus 108 tracks the trajectories (or flow patterns) of several dust particles 115 over time. For simplification, only three trajectories 1185i, 1185ii, 1185iii are labeled in FIG. 13, but there are many more that are observed.

The estimated property of the one or more dust particles 1178 can be used to adjust one or more features of the DUV light source 450 in which the gas discharge chamber 410 is implemented (1180). In one example, the adjustment to the DUV light source 450 can be to empty or replace the trap system 135 (if it is deemed to be full). For example, the visualization of the flow patterns of the dust particles 115 (such as the flow patterns of FIG. 13), permits additional analysis of dust particle flow behavior, and this can be used to improve the design of the gas discharge chamber 410 to reduce the chance of dust particle flow near the optical element 420. For example, the gas discharge chamber 410 can be modified by changing a rate at which gas is circulated through the cavity of the chamber 41. As another example, it is possible to troubleshoot performance issues associated with the gas discharge chamber 110 using the information obtained by tracking and counting the dust particles 115 that are in the vicinity of the optical element 120. As a further example, it is also possible to predict a lifetime of the optical element 120 based on the information obtained by tracking and counting the dust particles 115 that are in the vicinity of the optical element 120 or to determine how the number of dust particles in the vicinity of the optical element 120 would impact the lifetime of the optical element 120. The estimation of the speed or velocity of the dust particles 115 near the optical element 120 improves overall understanding of the flow behavior of the dust particles 115 near the optical element 120.

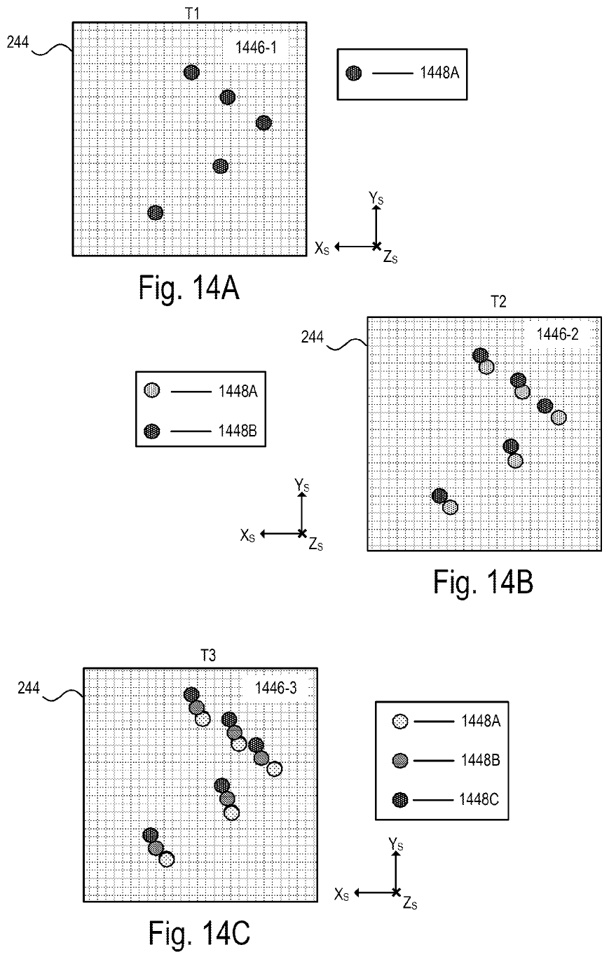

In one implementation, the processing apparatus 108 tracks the dust particles 115 as follows and with reference to FIGS. 14A-14C. At time T1, the detection apparatus 106 captures the image 1446-1 (FIG. 14A); at time T2, the detection apparatus 106 captures the image 1446-2 (FIG. 14B), and at time T3, the detection apparatus 106 captures the image 1446-3 (FIG. 14C). At time T1 (FIG. 14A), the processing apparatus 108 (and specifically the signal processing module 522) identifies the dust particles 115 (noted as regions of interest or shapes 1448A in FIG. 14A) within the image 1446-1. At time T2 (FIG. 14B), the processing apparatus 108 (and specifically the signal processing module 522) identifies the dust particles 115 (noted as regions of interest or shapes 1448B in FIG. 14B) within the image 1446-2, and also searches for dust particles 115 (noted as shapes 1448A in FIG. 14B) in the vicinity of the dust particles 115 that were detected in the previous image 1446-1. The dust particles 115 in the vicinity of the dust particles 115 that were detected in the previous image 1446-1 are represented by fading fill pattern (shapes 1448A) relative to the dust particles 115 detected in the current image 1446-2 (shapes 1448B). At time T3 (FIG. 14C), the processing apparatus 108 (and specifically the signal processing module 522) identifies the dust particles 115 (noted as regions of interest or shapes 1448C in FIG. 14C) within the image 1446-3, and also searches for dust particles 115 in the vicinity of the dust particles 115 that were detected in the previous image 1446-2 (noted as shapes 1448B in FIG. 14C). The dust particles 115 in the vicinity of the dust particles 115 that were detected in the previous image 1446-2 are represented by fading fill pattern (shapes 1448B) relative to the dust particles 115 detected in the current image 1446-3 (shapes 1448C). The dust particles 115 in the vicinity of the dust particles 115 that were detected in the image 1446-1 taken at time T1 are also displayed for reference as shapes 1448A in FIG. 14C. In this way, the processing apparatus 108 is able to track each dust particle over time.

The embodiments can be further described using the following clauses:
1. A metrology apparatus comprising:
a probe apparatus configured to produce a probe in a vicinity of an optical element that is in fluid communication with a gain medium of a gas discharge chamber and is exposed to one or more particles;
a detection apparatus configured to detect an interaction between the probe and one or more particles, and to produce an output signal based on the detected interaction; and
a processing apparatus configured to receive the output signal and to estimate a property of the one or more particles.
2. The metrology apparatus of clause 1, wherein the probe apparatus is an optical assembly and the probe is a light sheet, and the detection apparatus being configured to detect the interaction comprises the detection apparatus being configured to capture light produced from the interaction between the light sheet and the one or more particles.
3. The metrology apparatus of clause 2, wherein the optical assembly includes a laser configured to produce a laser light sheet as the light sheet.
4. The metrology apparatus of clause 3, wherein the laser is configured to produce light having a wavelength that is distinct from a wavelength of light produced from the gain medium in the gas discharge chamber.
5. The metrology apparatus of clause 2, wherein the detection apparatus includes a photodiode or a camera.
6. The metrology apparatus of clause 2, wherein an imaging plane of the detection apparatus faces the light sheet so that the extent of the light sheet is observable and imageable.
7. The metrology apparatus of clause 6, wherein the imaging plane of the detection apparatus faces a surface of the optical element that is in fluid communication with an interior of the gas discharge chamber.
8. The metrology apparatus of clause 2, wherein the light sheet is directed along a path that is nonparallel with a plane along which an amplified light beam travels through the gas discharge chamber, the amplified light beam being produced by the gain medium under the application of energy.
9. The metrology apparatus of clause 2, wherein the light sheet is directed along a path that is adjacent to a surface of the optical element. 10. The metrology apparatus of clause 2, wherein the optical element is a window of the gas discharge chamber disposed between an interior of the gas discharge chamber that is filled with the gain medium and an exterior of the gas discharge chamber, the window hermetically sealing the discharge chamber and being configured for an amplified light beam to pass therethrough.
11. The metrology apparatus of clause 10, wherein the light sheet is directed along a path that is adjacent to a surface of the window facing the interior of the gas discharge chamber.
12. The metrology apparatus of clause 10, wherein the light sheet is directed along a path that is in the vicinity of a surface of the window facing the interior of the gas discharge chamber.
13. The metrology apparatus of clause 2, wherein the detection apparatus being configured to capture light produced from the interaction between the light sheet and the one or more particles comprises capturing light from the light sheet that is scattered or reflected from the one or more particles.
14. The metrology apparatus of clause 2, wherein a probing axis of the light sheet lies in an imaging plane of the detection apparatus and one of:
a long plane of the light sheet is perpendicular with the imaging plane; or
the long plane of the light sheet is arranged to be at an angle that is between parallel with and perpendicular with the imaging plane.
15. The metrology apparatus of clause 2, wherein a probing axis of the light sheet lies in an imaging plane of the detection apparatus and a long plane of the light sheet is parallel with the imaging plane.
16. The metrology apparatus of clause 1, wherein the processing apparatus being configured to estimate a property of the one or more particles comprises the processing apparatus configured to estimate one or more of a number of the one or more particles, a location of the one or more particles, a density of the one or more particles, and a velocity of the one or more particles.
17. The metrology apparatus of clause 1, wherein the probe apparatus produces the probe in the vicinity of the optical element and the detection apparatus produces the output signal based on the detected interaction while the gas discharge chamber is producing an amplified light beam.
18. The metrology apparatus of clause 17, wherein the gas discharge chamber includes a gas containing a gain medium and electrodes for supplying energy to the gain medium such that the gain medium generates plasma that produces an amplified light beam when voltage is applied to the electrodes.
19. The metrology apparatus of clause 1, wherein the probe apparatus and the detection apparatus are arranged within or attached to a housing that holds the optical element.
20. An apparatus for a deep ultraviolet (DUV) gas discharge light source, the apparatus comprising:
a metrology apparatus comprising:
a probe apparatus configured to produce a probe in a vicinity of an optical element that is in fluid communication with a gain medium of a gas discharge chamber and is exposed to one or more particles;
a detection apparatus configured to detect an interaction between the probe and one or more particles, and to produce an output signal based on the detected interaction; and
a processing apparatus configured to receive the output signal and to estimate a property of the one or more particles; and
an actuation apparatus configured to receive the estimated property and adjust one or more features of the gas discharge light source based on the estimated property.
21. The apparatus of clause 20, further comprising a control apparatus in communication with the processing apparatus and the actuation apparatus, wherein the control apparatus is configured to analyze the estimated property, and analyze performance of the gas discharge chamber based on the analysis of the estimated property.
22. The apparatus of clause 21, wherein the control apparatus is configured to predict a lifetime of the optical element and/or the gas discharge chamber.
23. The apparatus of clause 21, wherein the actuation apparatus is configured to adjust one or more features of a dust particle trap system.
24. The apparatus of clause 20, wherein the particles comprise dust particles produced from the gain medium in the gas discharge chamber.
25. The apparatus of clause 24, wherein the gain medium includes a fluoride and the dust particles include metal fluoride particles.
26. The apparatus of clause 20, wherein the gain medium includes argon fluoride, krypton fluoride, or xenon chloride.
27. The apparatus of clause 20, wherein the metrology apparatus is associated with a power ring amplifier of the DUV gas discharge light source and the optical element is a window of the gas discharge chamber of the power ring amplifier.
28. The apparatus of clause 27, wherein the probe is arranged in the vicinity of the window of the gas discharge chamber of the power ring amplifier that is in fluid communication with a gain medium and is exposed to one or more particles.
29. The apparatus of clause 27, wherein the window of the gas discharge chamber of the power ring amplifier is the window at the output side of the gas discharge chamber of the power ring amplifier.
30. The apparatus of clause 27, wherein the window comprises a crystalline structure configured to transmit light having a wavelength in the DUV range.
31. The apparatus of clause 30, wherein the window comprises calcium fluoride, magnesium fluoride, or fused silica.
32. The apparatus of clause 20, wherein the probe apparatus is an optical assembly including a laser configured to produce a laser light sheet as the probe, and the detection apparatus being configured to detect the interaction comprises the detection apparatus being configured to capture light produced from the interaction between the light sheet and the one or more particles.
33. The apparatus of clause 32, wherein the laser is configured to produce light having a wavelength that is distinct from a wavelength of light produced from the gain medium in the gas discharge chamber.
34. The apparatus of clause 32, wherein the detection apparatus includes a photodiode or a camera.
35. The apparatus of clause 32, wherein the light sheet is directed along a path that is nonparallel with a plane along which an amplified light beam produced by the gain medium under the application of energy travels through the gas discharge chamber.
36. The apparatus of clause 32, wherein the laser light sheet is directed along a path that is adjacent to a surface of the optical element.
37. A metrology method comprising:
producing a probe in a vicinity of an optical element that is in fluid communication with a gain medium of a gas discharge chamber and is exposed to one or more dust particles;
detecting an interaction between the produced probe and the one or more dust particles;
producing an output signal based on the detected interaction; and
estimating a property of the one or more dust particles based on the output signal.
38. The metrology method of clause 37, wherein producing the probe comprises producing a laser light sheet and detecting the interaction comprises capturing light produced from the interaction between the light sheet and the one or more dust particles.
39. The metrology method of clause 38, wherein the laser light sheet has a wavelength that is distinct from a wavelength of light produced from the gain medium in the gas discharge chamber.
40. The metrology method of clause 38, wherein capturing the light produced from the interaction between the light sheet and the one or more dust particles comprises capturing light from the laser light sheet that is scattered or reflected from the one or more dust particles.

41. The metrology method of clause 40, wherein capturing the light from the laser light sheet that is scattered or reflected from the one or more dust particles comprises generating a potential difference at an exposure surface or generating a two-dimensional image at an exposure surface, the exposure surface receiving the scattered or reflected light from the laser light sheet.
42. The metrology method of clause 38, wherein producing the laser light sheet comprises directing the laser light sheet along a path that is nonparallel with a plane along which an amplified light beam produced by the gain medium under the application of energy, travels through the gas discharge chamber.
43. The metrology method of clause 42, wherein directing the laser light sheet along the path comprises directing the laser light sheet along a path that is adjacent to a surface of the optical element.
44. The metrology method of clause 37, wherein estimating the property of the one or more dust particles comprises estimating one or more of a number of the one or more dust particles, a location of the one or more dust particles, a density of the one or more dust particles, and a velocity of the one or more dust particles.
45. The metrology method of clause 37, wherein producing the probe in the vicinity of the optical element and producing the output signal based on the detected interaction occurs while the gas discharge chamber is producing an amplified light beam.

The above described implementations and other implementations are within the scope of the following claims.

1. A metrology apparatus comprising:
a probe apparatus configured to produce a probe in a vicinity of an optical element that is in fluid communication with a gain medium of a gas discharge chamber and is exposed to one or more particles;
a detection apparatus configured to detect an interaction between the probe and one or more particles, and to produce an output signal based on the detected interaction; and
a processing apparatus configured to receive the output signal and to estimate a property of the one or more particles.

2. The metrology apparatus of claim 1, wherein the probe apparatus is an optical assembly and the probe is a light sheet, and the detection apparatus is configured to capture light produced from the interaction between the light sheet and the one or more particles.

3. The metrology apparatus of claim 2, wherein the optical assembly includes a laser configured to produce a laser light sheet as the light sheet.

4. The metrology apparatus of claim 3, wherein the laser is configured to produce light having a wavelength that is distinct from a wavelength of light produced from the gain medium in the gas discharge chamber.

5. The metrology apparatus of claim 2, wherein the detection apparatus includes a photodiode or a camera.

6. The metrology apparatus of claim 2, wherein an imaging plane of the detection apparatus faces the light sheet so that the extent of the light sheet is observable and imageable.

7. The metrology apparatus of claim 6, wherein the imaging plane of the detection apparatus faces a surface of the optical element that is in fluid communication with an interior of the gas discharge chamber.

8. The metrology apparatus of claim 2, wherein the light sheet is directed along a path that is nonparallel with a plane along which an amplified light beam travels through the gas discharge chamber, the amplified light beam being produced by the gain medium under the application of energy.

9. The metrology apparatus of claim 2, wherein the light sheet is directed along a path that is adjacent to a surface of the optical element.

10. The metrology apparatus of claim 2, wherein the optical element is a window of the gas discharge chamber disposed between an interior of the gas discharge chamber that is filled with the gain medium and an exterior of the gas discharge chamber, the window hermetically sealing the discharge chamber and being configured for an amplified light beam to pass therethrough.

11. The metrology apparatus of claim 10, wherein the light sheet is directed along a path that is adjacent to a surface of the window facing the interior of the gas discharge chamber.

12. (canceled)

13. (canceled)

14. The metrology apparatus of claim 2, wherein a probing axis of the light sheet lies in an imaging plane of the detection apparatus and one of:
a long plane of the light sheet is perpendicular with the imaging plane; or
the long plane of the light sheet is arranged to be at an angle that is between parallel with and perpendicular with the imaging plane.

15. The metrology apparatus of claim 2, wherein a probing axis of the light sheet lies in an imaging plane of the detection apparatus and a long plane of the light sheet is parallel with the imaging plane.

16. The metrology apparatus of claim 1, wherein the processing apparatus being configured to estimate a property of the one or more particles comprises the processing apparatus configured to estimate one or more of a number of the one or more particles, a location of the one or more particles, a density of the one or more particles, and a velocity of the one or more particles.

17-19. (canceled)

20. An apparatus for a light source, the apparatus comprising:
a metrology apparatus comprising:
a probe apparatus configured to produce a probe in a vicinity of an optical element that is in fluid communication with a gain medium of a gas discharge chamber and is exposed to one or more particles;
a detection apparatus configured to detect an interaction between the probe and one or more particles, and to produce an output signal based on the detected interaction; and
a processing apparatus configured to receive the output signal and to estimate a property of the one or more particles; and
an actuation apparatus configured to receive the estimated property and adjust one or more features of the gas discharge light source based on the estimated property.

21. (canceled)

22. (canceled)

23. The apparatus of claim b 20, wherein the actuation apparatus is configured to adjust one or more features of a dust particle trap system.

24-31. (canceled)

32. The apparatus of claim 20, wherein the probe apparatus is an optical assembly including a laser configured to produce a laser light sheet as the probe, and the detection apparatus being configured to detect the interaction comprises the detection apparatus being configured to capture light produced from the interaction between the light sheet and the one or more particles.

33-36. (canceled)

37. A metrology method comprising:
producing a probe in a vicinity of an optical element that is in fluid communication with a gain medium of a gas discharge chamber and is exposed to one or more dust particles;
detecting an interaction between the produced probe and the one or more dust particles;
producing an output signal based on the detected interaction; and
estimating a property of the one or more dust particles based on the output signal.

38. The metrology method of claim 37, wherein producing the probe comprises producing a laser light sheet and detecting the interaction comprises capturing light from the light sheet that is scattered or reflected from the one or more dust particles.

39-41. (canceled)

42. The metrology method of claim 38, wherein producing the laser light sheet comprises directing the laser light sheet along a path that is nonparallel with a plane along which an amplified light beam produced by the gain medium under the application of energy, travels through the gas discharge chamber.

43-45. (canceled)
